(19) United States
(12) Patent Application Publication
(10) Pub. No.: US 2009/0028667 A1
(43) Pub. Date: Jan. 29, 2009

(54) DEVICE FOR COVERING A RECESS IN A CARRIER PART

(76) Inventor: Mohieddine Boubtane, Seyssinet-Pariset (FR)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/664,230

(22) PCT Filed: Jul. 28, 2005
(86) PCT No.: PCT/EP05/08171

§ 371 Date: Mar. 27, 2008

(30) Foreign Application Priority Data
Oct. 22, 2004 (DE) 10-2004-051-590.5

(51) Int. Cl. F16B 19/00

(52) U.S. Cl. 411/508

(57) ABSTRACT

The invention relates to a device for covering a recess in a carrier part (8), said device comprising a shaft (1) that can be guided through the recess (7), a covering screen (6) that is connected to the shaft (1) and laterally protrudes in relation to the same, and a catch arrangement (3, 4) connected to the shaft (1). Said catch arrangement (3, 4) is designed in such a way that it engages with the carrier part (8) when an axial force is applied to the shaft (1), and the covering screen (6) lies in a bearing region on a bearing side (11) of the carrier part (8). According to the invention, the covering screen (6) comprises a rigid peripheral outer section (9) and a peripheral deformation section (12) arranged between the outer section (9) and the shaft (1), said deformation section being less rigid than the outer section (9). In this way, the covering screen (6) can be prevented from pivoting even with the application of relatively high insertion forces.

The invention relates to a device in accordance with the introductory clause of patent claim 1.

A device of this type is known from DE 102 45 276 A1, for example. With a generic device, the recess can be covered with the covering screen after the shaft is inserted into the recess of the carrier part, and after an axial insertion force is exerted, when the catch arrangement engages with the carrier part. Upon engagement of the catch arrangement with the carrier part, deformation forces act upon the covering screen, leading to a relatively tight seating of the covering screen on the bearing side and thus to a proper covering of the recess.

With the generic devices, however, it has turned out that in the case of relatively large insertion forces, the covering screen has a tendency to bend up at the edges so that the edge of the covering screen exhibits a distance from the bearing surface in an objectionable way.

The invention is based on the problem of suggesting a device of the type mentioned above which is distinguished by proper covering even under high insertion forces.

According to the invention, this problem is solved with a device of the type mentioned above having the characterizing features of patent claim 1.

As a result of the fact that with the inventive device the covering screen is made with a deformation section that is relatively flexible in comparison with the relatively rigid outer section, the deformation forces are absorbed by the inner deformation section and thus a lifting of the outer section in the outer edge region is prevented.

Additional useful developments of the invention are the objects of the subclaims.

Additional useful developments and advantages are found in the following description of a preferred embodiment of the invention, including references to the figures of the drawing. The following are shown:

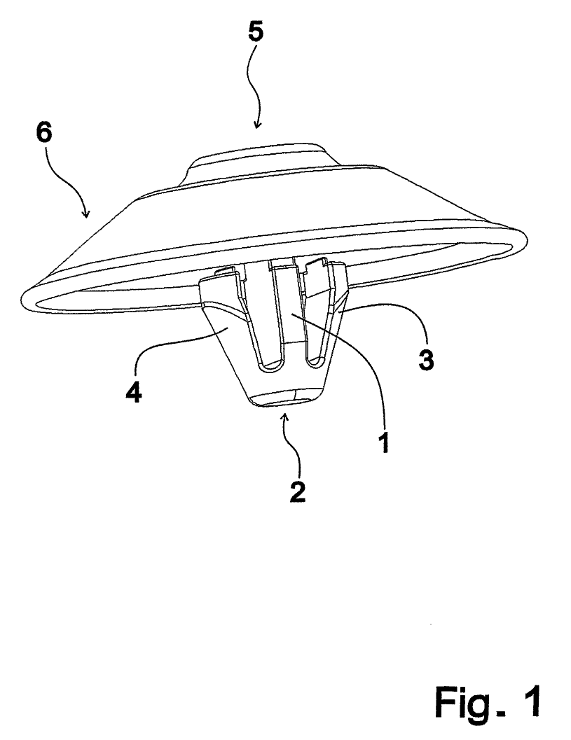

FIG. 1 A perspective view of an embodiment of the inventive device,

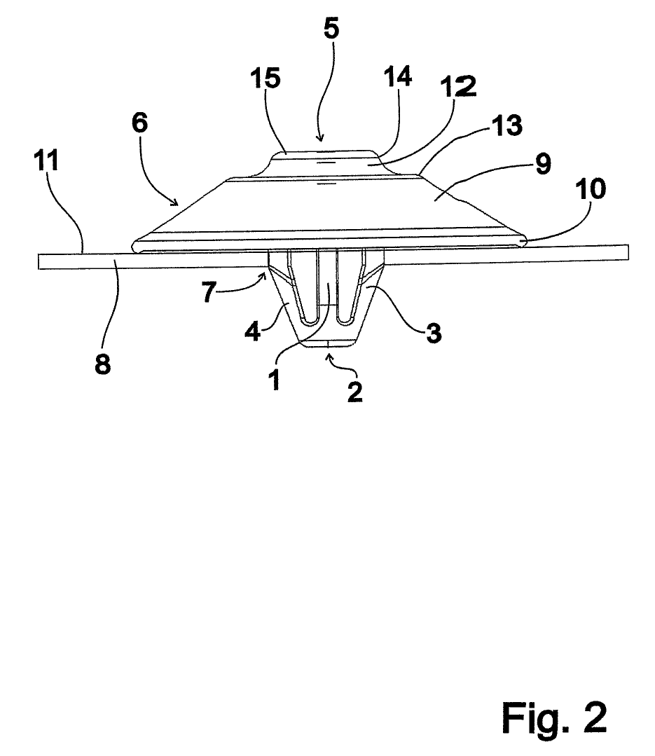

FIG. 2 The embodiment according to FIG. 1 in a side view prior to engagement with the carrier part, and

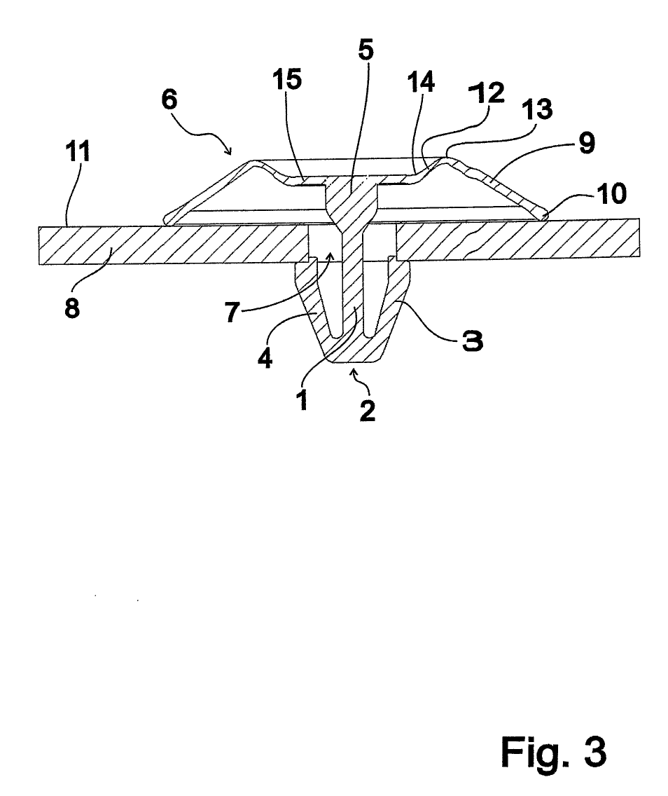

FIG. 3 The embodiment according to FIG. 1 and FIG. 2 in section view during engagement with the carrier part.

FIG. 1 shows a perspective view of an embodiment of the inventive device, which has an elongated shaft 1. Attached at a foot 2 of the shaft 1 in the illustrated embodiment are two springy side arms 3, 4 of a catch arrangement, which extend on both sides of the shaft 1 and at a lateral distance from same pointing away from the foot 2 in the direction of a top 5 of the shaft 1.

In addition, the inventive device is configured with a funnel-like covering screen 6, which in the illustrated embodiment is connected in the region of the top 5 to the shaft 1. In the illustrated embodiment, the covering screen 6 has a round configuration and opens in the direction of the foot 2.

FIG. 2 shows the embodiment according to FIG. 1 in a side view. In the arrangement according to FIG. 2, the shaft 1 of the device is inserted into a recess 7 of a carrier part 8, and the side arms 3, 4 stand just prior to engagement with a carrier part 8. It can be seen from FIG. 2 that the covering screen 6 comprises a peripheral outer section 9, which terminates the covering screen 6 radially on the outside and on the outer edge of which there is configured a thickened edge bead 10, which in the arrangement according to FIG. 2 lies in a bearing region on a bearing side 11 of the carrier part 8.

From FIG. 2, it can be seen that adjoining the outer section 9 is a peripheral deformation section 12, which extends from an outer peripheral line 13 that delimits the outer section 9 radially on the inside to an inner peripheral line 14 that delimits the deformation section 12 radially on the inside. In the unstressed state according to FIG. 2, the deformation section 12 extends in the region of the outer peripheral line 13 relative to the outer section 9 and forms a shoulder with a smaller angle in the direction of the longitudinal direction of the shaft 1 than the outer section 9, whereby this angle increases again with radially increasing distance from the outer peripheral line 13.

Moreover, the covering screen 6 is designed with a plate-like inner section 15, which is placed to the inside of the inner peripheral line 14 and is connected to the shaft 1. In this unstressed state, the inner section 15 protrudes axially beyond the outer section 9. As a result, the shaft 1 can be moved in the axial direction over a relatively large displacement path upon exertion of an insertion force acting axially in the direction of the carrier part 8.

The outer section 9 of the covering screen 6 is made relatively rigid. The deformation section 12, on the other hand, exhibits less rigidity than the outer section 9, while the inner section 15 in turn has greater rigidity than the deformation section 12. In conjunction with that, the inventive device is produced from a uniform plastic material, preferably in its entirety but at least the covering screen 6.

FIG. 3 shows the embodiment according to FIGS. 1 and 2 in a section view during engagement of the side arms 3, 4 with the carrier part 8. In FIG. 3, it can be seen that in the illustrated embodiment the material thickness of the deformation section 12, at least in some sections, is smaller than that of the outer section 9 as well as smaller than that of the inner section 15. In addition, it can be seen from FIG. 3 that in the illustrated embodiment the material thickness increases continuously from the outer peripheral line 13 to the edge bead 10, so that the rigidity of the outer section 9 is greatest at the outside.

Thus, starting from the unstressed arrangement illustrated in FIG. 2, after an axial insertion force acting on the inner section 15 in the direction of the carrier part 8 has been exerted until the side arms 3, 4 engage behind the carrier part 8, in this stressed arrangement the deformation section 12, which is less rigid and therefore more easily deformable than the outer section 9, is bent radially inward relative to the arrangement illustrated in FIG. 2, so that the inner section 15 is arranged between the outer peripheral line 13 and the edge bead 10.

As a result of the inventive configuration of the covering screen 6, the deformation of the covering screen 6 takes place upon exertion of even relatively high insertion forces, as is the case, for example, with relatively thick carrier parts 8, defined in the relatively easily deformable, flexible deformation section 12, while the outer section 9, which by comparison is relatively stiff, is deformed very little or not at all, and in addition, a discontinuous change of its funnel-like shape, bending and with the edge bead 10 standing away from the bearing side 11, is prevented.

1. Device for covering a recess in a carrier part (8), having a shaft (1) that can be guided through a recess (7), a covering screen (6) that is connected to the shaft (1) and protrudes laterally relative to same, and a catch arrangement (3, 4) that is connected to the shaft (1), whereby the catch arrangement (3, 4) is designed in such a way that it engages with the carrier part (8) when an axial force is applied to the shaft (1) and the covering screen (6) lies in a bearing region on a bearing side (11) of the carrier part (8), whereby the covering screen (6) exhibits a rigid peripheral outer section (9) and has a peripheral deformation section (12) which is arranged between the outer section (9) and the shaft (1) and which exhibits less rigidity than the outer section (9), characterized in that the covering screen (6) is configured funnel-like and is open in the direction of a foot (2) of the shaft (1), and that configured between the deformation section (12) and the shaft (1) is a rigid peripheral inner section (15), which has rigidity that is greater than the rigidity of the deformation section (12).

2. Device according to claim 1, characterized in that the covering screen (6) is made of a uniform plastic material.

3. Device according to claim 1, characterized in that the deformation section (12) exhibits less material thickness than the outer section (9).

4. Device according to claim 1, characterized in that the material thickness of the outer section (9) increases continuously from radially inside to radially outside.

5. Device according to claim 1, characterized in that in an unstressed state the inner section (15) protrudes axially beyond the outer section (9).

6. Device according to claim 2, characterized in that the deformation section (12) exhibits less material thickness than the outer section (9).

7. Device according to claim 2, characterized in that the material thickness of the outer section (9) increases continuously from radially inside to radially outside.

8. Device according to claim 3, characterized in that the material thickness of the outer section (9) increases continuously from radially inside to radially outside.

9. Device according to claim 2, characterized in that in an unstressed state the inner section (15) protrudes axially beyond the outer section (9).

10. Device according to claim 3, characterized in that in an unstressed state the inner section (15) protrudes axially beyond the outer section (9).

11. Device according to claim 4, characterized in that in an unstressed state the inner section (15) protrudes axially beyond the outer section (9).
